(19) United States
(12) Patent Application Publication
(10) Pub. No.: US 2023/0297995 A1
(43) Pub. Date: Sep. 21, 2023

(54) ALLOCATING PAYMENT TRANSACTION PORTIONS TO MORE THAN ONE FUNDING SOURCE VIA A SINGLE CARD

(71) Applicant: Marqeta, Inc., Oakland, CA (US)

(72) Inventors: Mark Daniel Cline, Alameda, CA (US); Ashik Uzzaman, Fremont, CA (US)

(21) Appl. No.: 17/655,750

(22) Filed: Mar. 21, 2022

(51) Int. Cl. G06Q 20/32; G06Q 20/40; G06Q 20/22

(52) U.S. Cl. CPC G06Q 20/3278; G06Q 20/405; G06Q 20/4014; G06Q 20/227

(57) ABSTRACT

This disclosure describes methods, non-transitory computer readable storage media, and systems that utilize a card to provide multi-funding source payment transactions between a plurality of users and a merchant system. For example, in response to a request to process a multi-funding source transaction for a card in connection with a merchant system, the disclosed system accesses an account mapping to determine whether to process the transaction utilizing a plurality of funding sources associated with the card (e.g., based on transaction attributes or merchant attributes). The disclosed system also utilizes the account mapping to determine proportions for processing the transaction with the plurality of funding sources. Additionally, the disclosed system generates authorization messages to send to one or more payment networks for processing the multi-funding source payment transaction utilizing the plurality of funding sources for specific payment amounts based on the proportions.

### BACKGROUND

Electronic payment transactions and online banking via client devices (e.g., desktop devices and mobile devices) are increasingly prevalent. For example, many entities (e.g., banks) provide tools that allow customers to engage in payment transactions with other users (e.g., peer-to-peer payment transactions or peer-to-business payment transactions). Additionally, many entities have provided online availability of a number of operations by providing websites and proprietary applications. To illustrate, these websites and proprietary applications include capabilities for engaging in electronic payment transactions utilizing credit/debit cards via mobile devices.

While many existing systems provide online or mobile integration of electronic payment systems for users to engage in payment transactions via online or mobile platforms, these conventional systems are rigidly limited to processing specific types of transactions. In particular, conventional systems limit peer-to-business electronic payment transactions to a one-to-one structure in which a single person engages in a transaction with a single merchant (e.g., a single customer utilizes a physical or digital credit card to complete a purchase at a business). For example, the conventional systems restrict payment transactions to the one-to-one structure due to the slow changing nature of payment networks (e.g., the various card networks, issuing banks, gateway payment systems) and the difficulty of changing hardware (e.g., point-of-sale devices) and software (e.g., online applications) of merchants to integrate with the payment networks. In many instances, modifying the structure of payment transactions given the limitations of the payment networks and merchant systems (e.g., hardware and software) is not possible via the infrastructure/design of the conventional systems. Accordingly, the conventional systems lack flexibility and efficiency in facilitating electronic payment transactions for users and merchants.

### SUMMARY

This disclosure describes one or more embodiments of methods, non-transitory computer readable media, and systems that solve the foregoing problems (in addition to providing other benefits). Specifically, in one or more embodiments, the disclosed systems utilize a single card to provide multi-funding source payment transactions between a plurality of users and a merchant system. For example, in response to a request to process a multi-funding source transaction for a card in connection with a merchant system, the disclosed systems access an account mapping to determine whether to process the transaction utilizing a plurality of funding sources associated with the card (e.g., based on transaction attributes or merchant attributes). The disclosed systems also utilize the account mapping to determine proportions for processing the transaction with the plurality of funding sources. Additionally, the disclosed systems generate authorization messages to send to one or more payment networks for processing the multi-funding source payment transaction utilizing the plurality of funding sources for specific payment amounts based on the proportions. By utilizing a card linked to a plurality of different payment accounts to process payment transactions, the disclosed systems provide secure, flexible, and efficient multi-funding source transactions with existing payment network and merchant hardware/software infrastructure.

### BRIEF DESCRIPTION OF THE DRAWINGS

The detailed description refers to the drawings briefly described below.

FIG. 1 illustrates a block diagram of a system environment in which a card system is implemented in accordance with one or more implementations.

FIG. 2 illustrates a diagram of an overview of a process for processing multi-funding source transactions with merchant systems in accordance with one or more implementations.

FIG. 3 illustrates a sequence-flow diagram of a process for creating an account mapping for a card and a plurality of payment accounts in accordance with one or more implementations.

FIGS. 4A-4B illustrate a sequence-flow diagram of a process for processing a multi-funding source payment transaction in accordance with one or more implementations.

FIGS. 5A-5E illustrate graphical user interfaces for configuring a card in connection with a plurality of payment accounts in accordance with one or more implementations.

FIGS. 6A-6B illustrate graphical user interfaces for processing a multi-funding source payment transaction in accordance with one or more implementations.

FIG. 7 illustrates a flowchart of a series of acts for processing a multi-funding source payment transaction involving a plurality of funding payment accounts in accordance with one or more implementations.

FIG. 8 illustrates a block diagram of an exemplary computing device in accordance with one or more implementations.

### DETAILED DESCRIPTION

This disclosure describes one or more embodiments of a card system that utilizes cards to process multi-funding source transactions involving a plurality of separate funding payment accounts. Specifically, the card system utilizes an account mapping between a card and two or more payment accounts to process a multi-funding source transaction with a merchant. For example, users can utilize the card to engage in individual or recurring payment transactions with the merchant to fund the payment transactions according to defined proportions and other parameters of the card. For example, in response to a request message for a multi-funding source transaction involving a card identification number, the card system accesses the account mapping to determine how to process the transaction. The card system determines funding proportions corresponding to the payment accounts based on the account mapping and a transaction amount for the multi-funding source transaction. Additionally, the card system processes the multi-funding source transaction by generating separate authorization messages for the different funding proportions and payment accounts.

As mentioned, in one or more embodiments, the card system initiates a transaction process in response to receiving a request message from a merchant system to process a payment transaction. In particular, the card system receives a request message including information associated with the transaction for initiating and processing the transaction. For instance, the request message includes a transaction amount and a card identification number. In some embodiments, the merchant system issues the request message in response to a transaction via a point-of-sale device or an application or website associated with the merchant system. In additional embodiments, the merchant system initiates the transaction without having access to information that the transaction is a multi-funding source transaction (e.g., multi-funding source information is obfuscated to the merchant). Accordingly, the card system determines that the transaction is a multi-funding source transaction based on information provided in the request message without the merchant system having knowledge of the multi-funding source configuration of the transaction.

In one or more embodiments, upon receiving authorization for the transaction the card system determines separate proportions corresponding to a plurality of payment accounts in connection with a multi-funding source transaction. Specifically, the card system accesses an account mapping in an account mapping database based on the card identification number in the request message. To illustrate, the card system determines a plurality of payment options associated with the card identification number from the account mapping. For example, the card system determines that two individual payment accounts may be used to each pay for (“fund”) 50% of a given payment transaction. Additionally, the card system determine the proportions (e.g., portions of the transaction amount) for each of the payment accounts based on the account mapping.

According to one or more embodiments, the card system generates authorization messages to send to the source payment accounts. For example, the card system generates a first authorization message to authorize the multi-funding source transaction against a first payment account for a first proportion of a transaction amount. Additionally, the card system generates N number of subsequent authorization messages to authorize the multi-funding source transaction against additional payment accounts for corresponding proportions of the transaction amount until the combined proportions meet the full amount of the transaction. The card system sends the authorization messages to one or more card payment networks or other payment networks or ledger accounts corresponding to the payment accounts to process the multi-funding source transaction.

In some embodiments, the card system also manages account mappings for cards. In particular, the card system generates a card with an account mapping between a card identification number of the card and a plurality of payment accounts. Furthermore, the card system determines multi-funding source transaction parameters associated with the card for processing multi-funding source transactions involving the card identification number. To illustrate, the multi-funding source transaction parameters define percentages, amounts, and/or transaction configuration parameters for determining when and how to process multi-funding source transactions involving the card identification number.

The disclosed card system provides a number of benefits over conventional systems. For example, the card system improves the flexibility and efficiency of computing systems that process electronic payment transactions. In contrast to existing systems that are rigidly limited to one-to-one transaction structures (e.g., between a single payor and a single recipient), the card system enables electronic multi-funding source transactions funded by a plurality of different sources. Specifically, the card system maps a card to a plurality of payment accounts for funding a single transaction between the card and a merchant system while utilizing existing payment hardware/software infrastructure.

The card system also improves the efficiency of computing systems by leveraging a many-to-one structure in electronic transactions. Specifically, in contrast to existing payment systems that restrict transactions to one-to-one transactions (thus requiring the processing of multiple one-to-one transactions to fund a purchase via a plurality of payment accounts), the card system utilizes existing hardware/software infrastructure to enable many-to-one transactions. To illustrate, by utilizing an intermediate card with its own card identification number to initiate a payment transaction with a merchant system, the card system is able to leverage existing payment infrastructure to utilize a plurality of payment accounts while appearing to the merchant system as a single funding entity. Furthermore, by modifying the transaction process via a card mapped to a plurality of accounts, the card system eliminates the need for merchant systems and payment networks to perform any integration or processing steps to enable multi-funding source transactions. Additionally, processing multi-funding source transactions via a card allows the card system to set up a consistent/recurring payment transaction involving a plurality of funding sources for a purchase or payment without requiring separate devices and/or user interactions associated with the separate payment accounts, thereby eliminating extra steps in transaction processes typical of conventional systems.

Additionally, the card system provides additional security in electronic payment transactions via the use of cards. For instance, in contrast to conventional systems that rely on third-party systems (e.g., payment card networks) to detect fraudulent transactions, the card system provides preventative control over electronic payment transactions via the cards. In particular, the card system provides fine-grained control over whether to initiate/process transactions via a card based on a number of different user-defined parameters, including device/merchant location data, date/time, transaction types, etc. Accordingly, the card system allows a user (in connection with an account mapping of a card) to establish specific parameters for determining whether to initiate a given payment transaction.

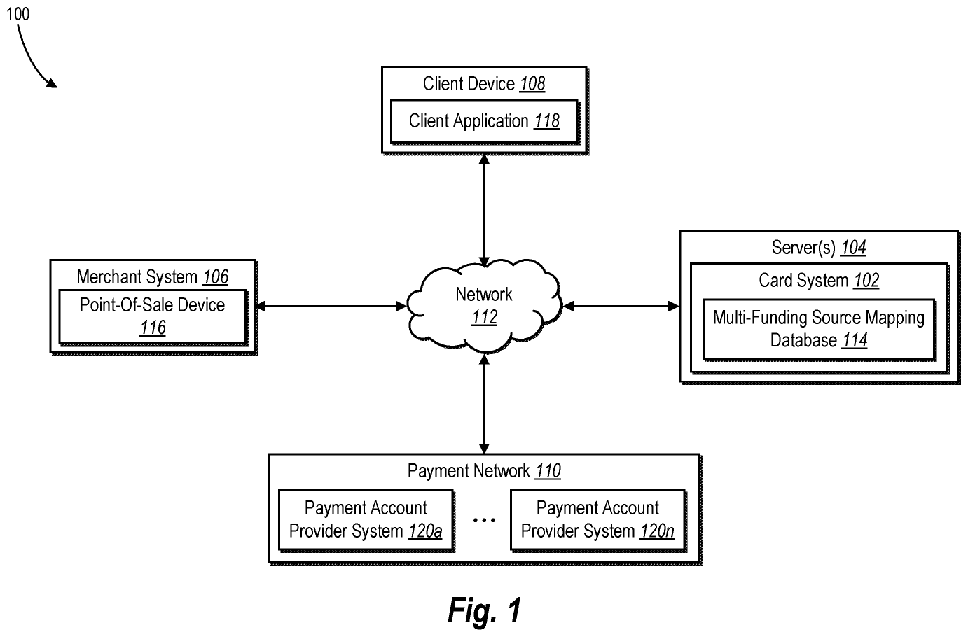

Turning now to the figures, FIG. 1 includes an embodiment of a system environment 100 in which a card system 102 operates. In particular, the system environment 100 includes server(s) 104, a merchant system 106, a client device 108, and a payment network 110 in communication via a network 112. Moreover, as shown, the card system 102 includes a multi-funding source mapping database 114. FIG. 1 also illustrates that the merchant system 106 includes a point-of-sale device 116, and the client device 108 includes a client application 118. Furthermore, as shown, the payment network 110 includes a plurality of payment account provider systems 120a-120n.

As shown, in FIG. 1, the server(s) 104 include or host the card system 102. The server(s) 104 communicate with one or more other components in the system environment 100 to manage cards for a plurality of users and payment accounts. For example, the card system 102 communicates with the client device 108 to manage a card associated with one or more funding sources. As used herein, the term “card” refers to a card account for use in engaging in electronic payment transactions. For example, a card can include a physical card or a virtual card (e.g., a digital version stored on a computing device). Additionally, in one or more embodiments, a card is associated with one or more additional payment accounts, such as one or more credit cards, one or more debit cards, one or more gift cards, one or more ledgers carrying a balance available for use as a payment, one or more cryptocurrency accounts or balances, or one or more deposit accounts (e.g., checking accounts or demand deposit accounts). For example, the card system 102 communicates with the client device 108 to manage a card associated with a plurality of separate payment accounts for one or more users.

In one or more embodiments, in connection with managing cards for users, the card system includes the multi-funding source mapping database 114 to map the cards to corresponding payment accounts. In particular, the multi-funding source mapping database 114 includes account mappings between card identification numbers associated with the cards and payment accounts and payment credentials (e.g., credit/debit card numbers or account numbers) of corresponding payment accounts. In some embodiments, a card identification number includes a unique 16-digit number that refers to a specific card (e.g., similar to a credit card number). In addition, the card identification number may be tokenizable (e.g., capable of being tokenized by one or more account tokenization systems for securely processing payment transactions). As used herein, the term “account mapping” refers to an entry stored in a database that links a card identification number to one or more payment accounts of one or more users. Additionally, the multi-funding source mapping database 114 includes (e.g., with account mappings) parameters associated with processing multi-funding source payment transactions involving cards.

As used herein, the term “multi-funding source transaction” refers to an electronic payment transaction in which a plurality of payment accounts fund a payment to a single merchant using a single card. For instance, a multi-funding source transaction includes an electronic payment transaction between two or more payment accounts associated with a card and a merchant system (e.g., the merchant system 106). A multi-funding source transaction can include a single transaction (e.g., friends or coworkers paying for a meal at a restaurant) or a recurring transaction (e.g., roommates or spouses paying for rent or a phone bill) between a plurality of separate payment accounts and a single recipient. In one or more embodiments, a multi-funding source transaction involves a plurality of payment accounts associated with a single user or a plurality of users.

As illustrated in FIG. 1, the client device 108 initiates a multi-funding source transaction with the merchant system 106 in connection with a card that is mapped to a plurality of payment accounts. To illustrate, the client device 108 utilizes the client application 118 (e.g., a digital wallet application) to provide a card identification number associated with the card to the point-of-sale device 116 of the merchant system 106 (or via a website or application associated with the merchant system 106). In additional embodiments, the card system 102 also allows management of parameters associated with the card via the client application 118 of the client device 108 and the multi-funding source mapping database 114 of the card system 102.

The card system 102 processes multi-funding source transactions by communicating with the payment network 110 to transfer funds from various payment accounts to merchant accounts. In one or more embodiments, the payment network 110 includes a plurality of payment account provider systems 120a-120n that provide payment accounts for users. For instance, the payment account provider systems 120a-120n include payment card networks (e.g., VISA, DISCOVER, or MASTERCARD), issuing or acquiring bank systems, or other systems that provide access to funds via credit card accounts, debit card accounts, checking accounts, ledgers, cryptocurrency accounts, etc. To illustrate, a payment account provider system can provide payment accounts of one or more payment account types to one or more users. In addition to the payment account provider systems 120a-120n, in some embodiments, the payment network 110 includes gateway payment systems and other devices or systems involved in processing electronic payment transactions. In one or more embodiments, one or more of the payment account provider systems 120a-120n include proprietary systems associated with the card system 102 or with a third party that provide ledgers or other payment sources carrying balances available for use in payment transactions.

In one or more embodiments, in connection with managing cards, the card system 102 also provides one or more additional systems or devices with card management tools. For example, the one or more additional systems or devices include the client device 108 and/or the payment account provider systems 120a-120n of the payment network 110. In one or more embodiments, the card system 102 provides one or more application programming interfaces (“APIs”) for the systems or devices to configure a card and generate an account mapping to one or more payment accounts with a plurality of parameters. To illustrate, payment account provider systems can communicate with the card system 102 via interfacing protocols of the API to provide card management tools at a client device of a user.

In one or more embodiments, the card system 102 securely communicates with the merchant system 106 and the payment network 110 (e.g., the server(s) 104 securely communicates with the merchant system 106 and the payment network 110) to process electronic payment transactions with cards. In particular, the card system 102 utilizes encryption to verify and authenticate data passed to and from the merchant system 106 and/or the payment network 110 in connection with processing electronic payment transactions. More specifically, the card system 102 provides one or more APIs that the merchant system 106 and/or the payment networks 110 leverage to securely communicate with the card system 102 for card management and payment transaction processing.

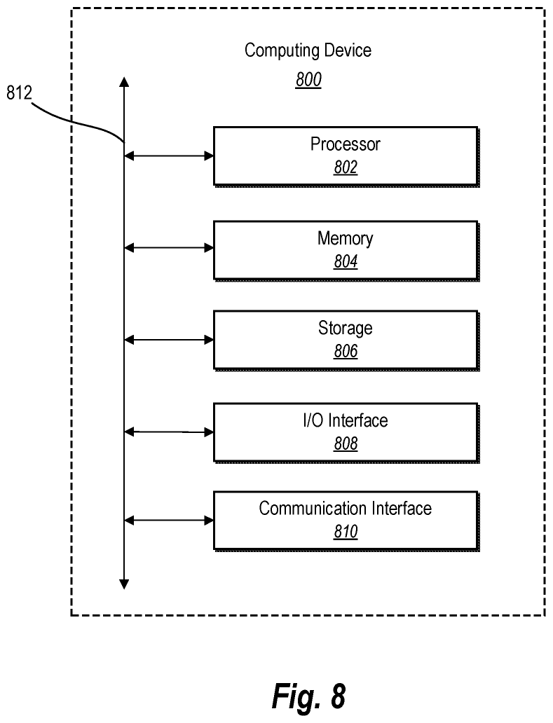

In one or more embodiments, the server(s) 104 include a variety of computing devices, including those described below with reference to FIG. 8. For example, the server(s) 104 includes one or more servers for storing and processing data associated with card management and multi-funding source transactions. In some embodiments, the server(s) 104 also include a plurality of computing devices in communication with each other, such as in a distributed storage environment. In some embodiments, the server(s) 104 communicate with a plurality of issuing systems and issuing system devices (e.g., payment account provider systems 120a-120n) based on established relationships between the card system 102 and the issuing systems. In additional embodiments, the server(s) 104 communicate with other entities or systems including financial institutions (e.g., issuing banks associated with payment cards), payment card networks associated with processing payment transactions involving payment cards, payment gateways, merchant systems, client devices, or other systems.

In addition, in one or more embodiments, the card system 102 is implemented on one or more servers. For example, while FIG. 1 illustrates a single server (i.e., server(s) 104), the card system 102 can be partially or fully implemented on a plurality of servers. To illustrate, the card system 102 can be implemented in a distributed environment. In one or more embodiments, each server handles requests for one or more cards for a plurality of payment accounts of a plurality of users. In additional embodiments, although FIG. 1 illustrates that the card system 102 includes the multi-funding source mapping database 114 on the server(s) 104, the multi-funding source mapping database 114 may be part of one or more other servers or systems.

Additionally, as shown in FIG. 1, the system environment 100 includes the network 112. The network 112 enables communication between components of the system environment 100. In one or more embodiments, the network 112 may include the Internet or World Wide Web. Additionally, the network 112 can include various types of networks that use various communication technology and protocols, such as a corporate intranet, a virtual private network (VPN), a local area network (LAN), a wireless local network (WLAN), a cellular network, a wide area network (WAN), a metropolitan area network (MAN), or a combination of two or more such networks. Indeed, the server(s) 104, the card system 102, the merchant system 106 and the client device 108 communicate via the network 112 using one or more communication platforms and technologies suitable for transporting data and/or communication signals, including any known communication technologies, devices, media, and protocols supportive of data communications, examples of which are described with reference to FIG. 8. Additionally, in one or more embodiments, one or more of the various components of the system environment 100 communicate using protocols for payment card transactions, financial information communications such as payment card industry (“PCI”) standards, or other protocols.

In addition, as shown in FIG. 1, the system environment 100 includes the client device 108. In one or more embodiments, the client device 108 includes, but is not limited to, a mobile device (e.g., smartphone or tablet), a laptop, a desktop, including those explained below with reference to FIG. 8. Furthermore, although not shown in FIG. 1, the client device 108 can be operated by a user (e.g., a user included in, or associated with, the system environment 100) to perform a variety of functions. In particular, the client device 108 performs functions such as, but not limited to, accessing, viewing, and interacting with a card or a card account. In some embodiments, the client device 108 also performs functions for initiating operations for engaging in payment transactions utilizing a card, managing preferences/parameters associated with the card, or adding or removing payment accounts associated with the card. For example, the client device 108 communicates with the server(s) 104 via the network 112 to provide information (e.g., user interactions and/or data) associated with managing a card. Although FIG. 1 illustrates the system environment 100 with a single client device, in some embodiments, the system environment 100 includes a different number of client devices.

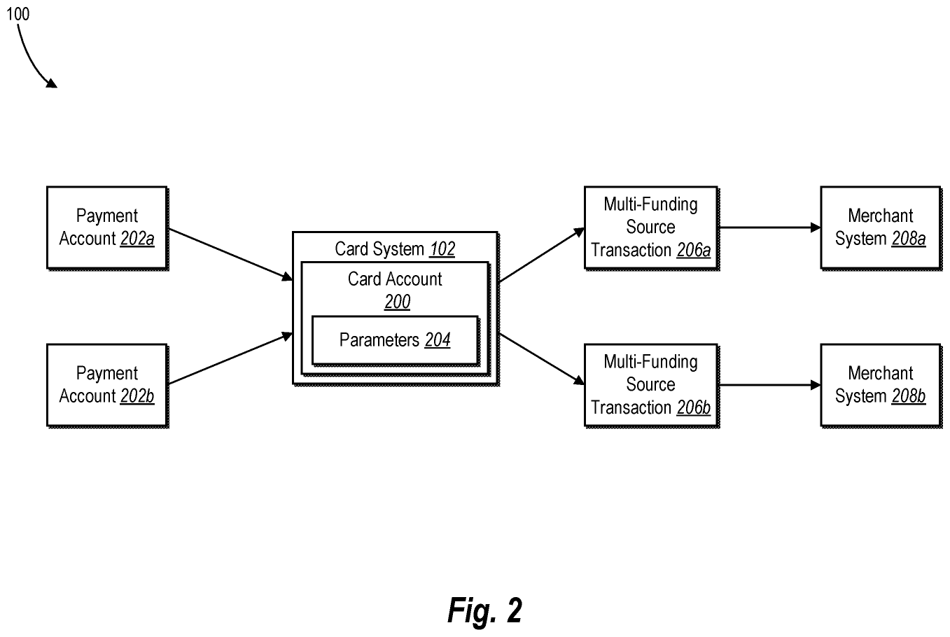

As mentioned, the card system 102 provides management of cards for multi-funding source transactions. FIG. 2 illustrates a process in which the card system 102 enables multi-funding source transactions involving more than one funding payment account. Specifically, FIG. 2 illustrates that the card system 102 links a plurality of different payment accounts to a card to facilitate a plurality of multi-funding source transactions involving a plurality of payment accounts with a plurality of merchant systems.

In one or more embodiments, FIG. 2 illustrates that the card system 102 maps a card account 200 for a card to a first payment account 202a and a second payment account 202b. In one or more embodiments, the card account 200 is associated with a card corresponding to a specific user or client device. In particular, the card system 102 generates an account mapping for the card account 200 by linking a card identification number of the card to the first payment account 202a and the second payment account 202b.

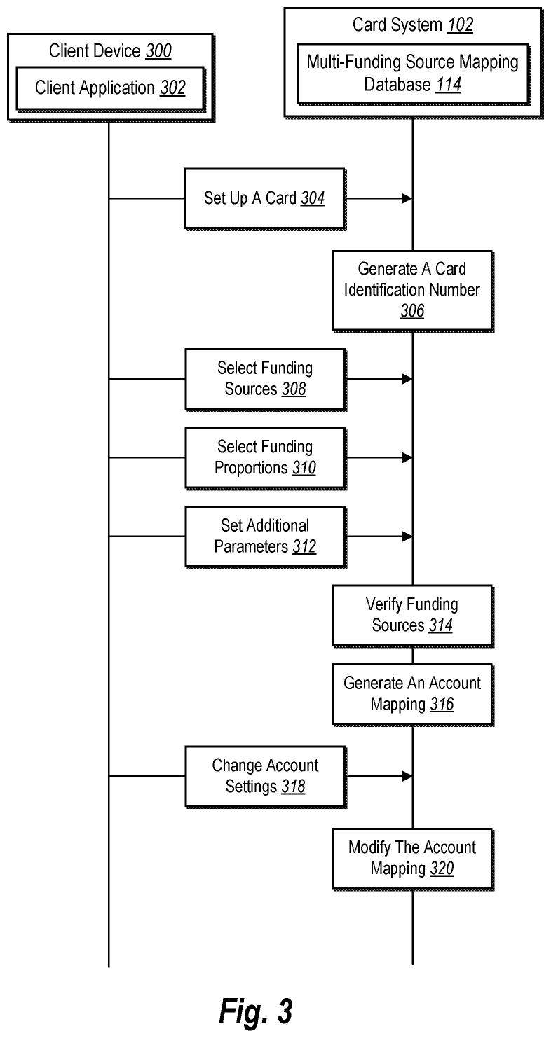

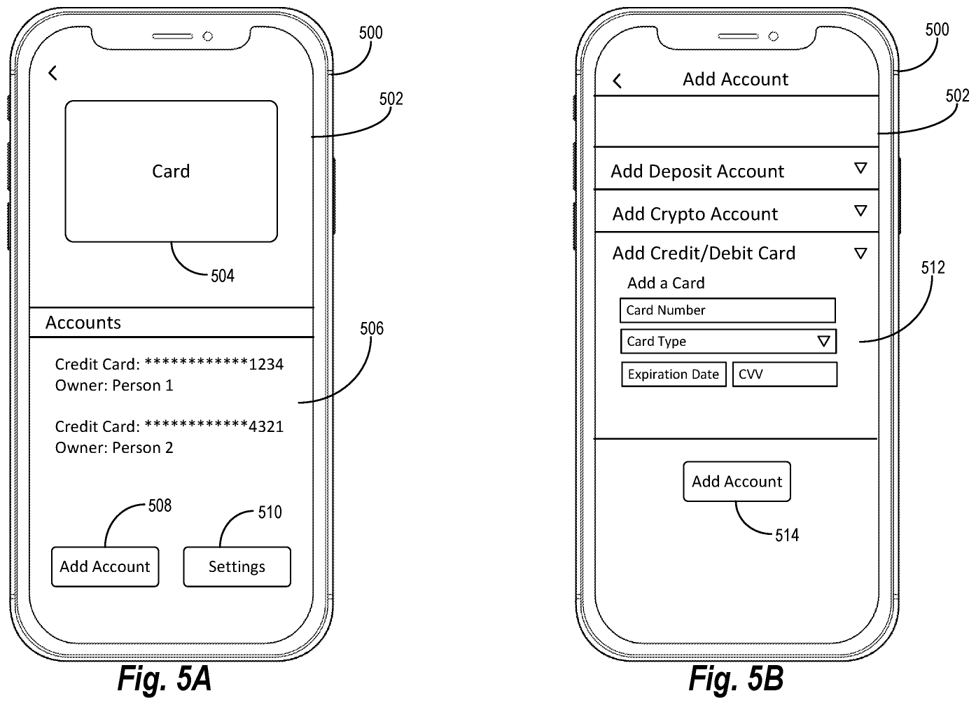

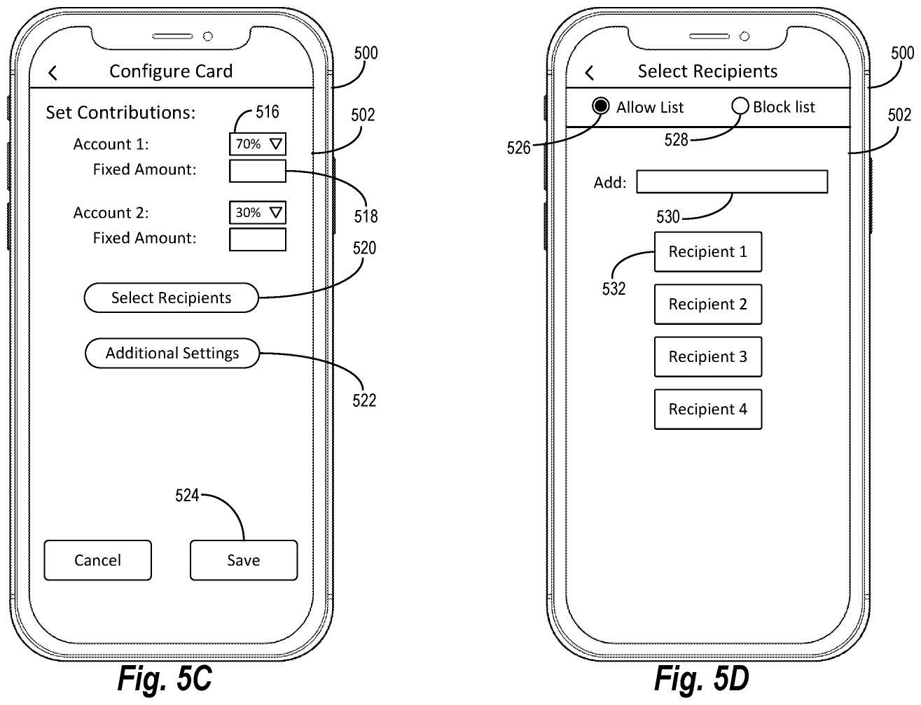

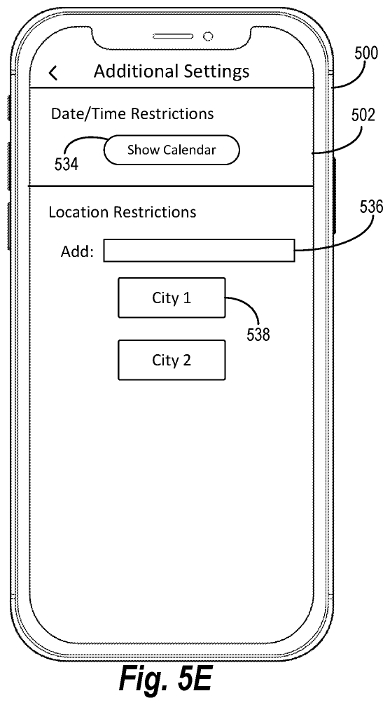

In one or more embodiments, the card system 102 links the card identification number of the card to the first payment account 202a and the second payment account 202b with parameters 204 for the card account 200. For example, as described in more detail with respect to FIG. 3 and FIGS. 5A-5E, the card system 102 provides tools for linking a plurality of payment accounts of one or more account types to a single card. Additionally, the card system 102 stores parameters 204 for determining how to process electronic payment transactions involving the card account 200 (e.g., payment account proportions) with the account mapping.

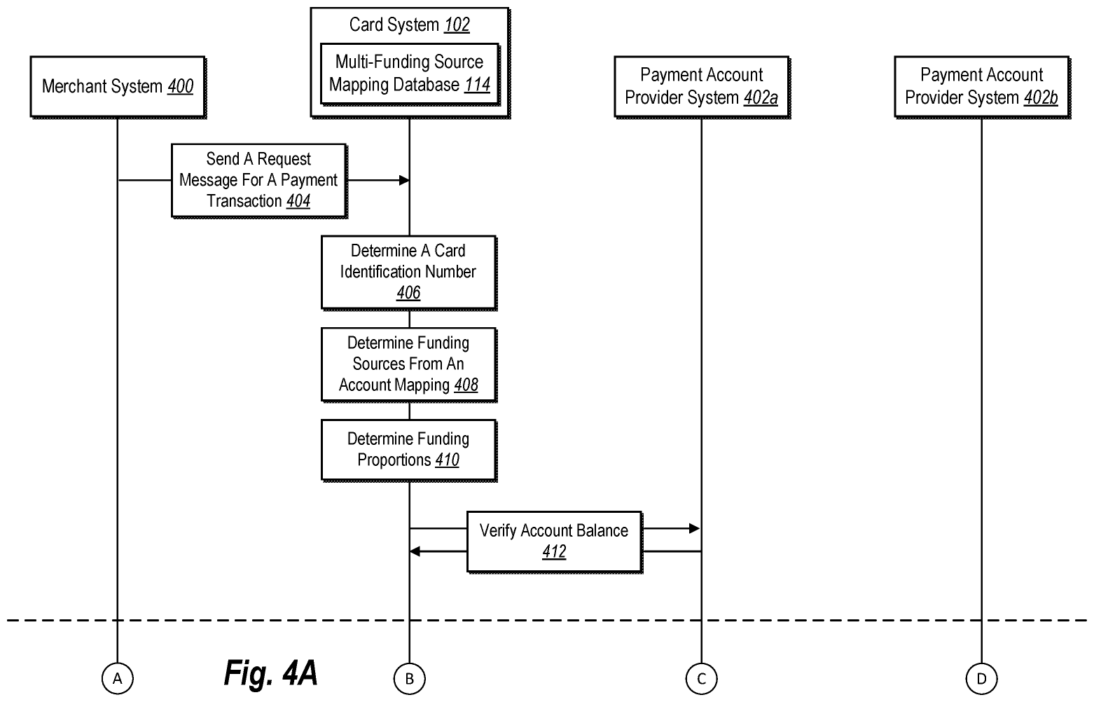

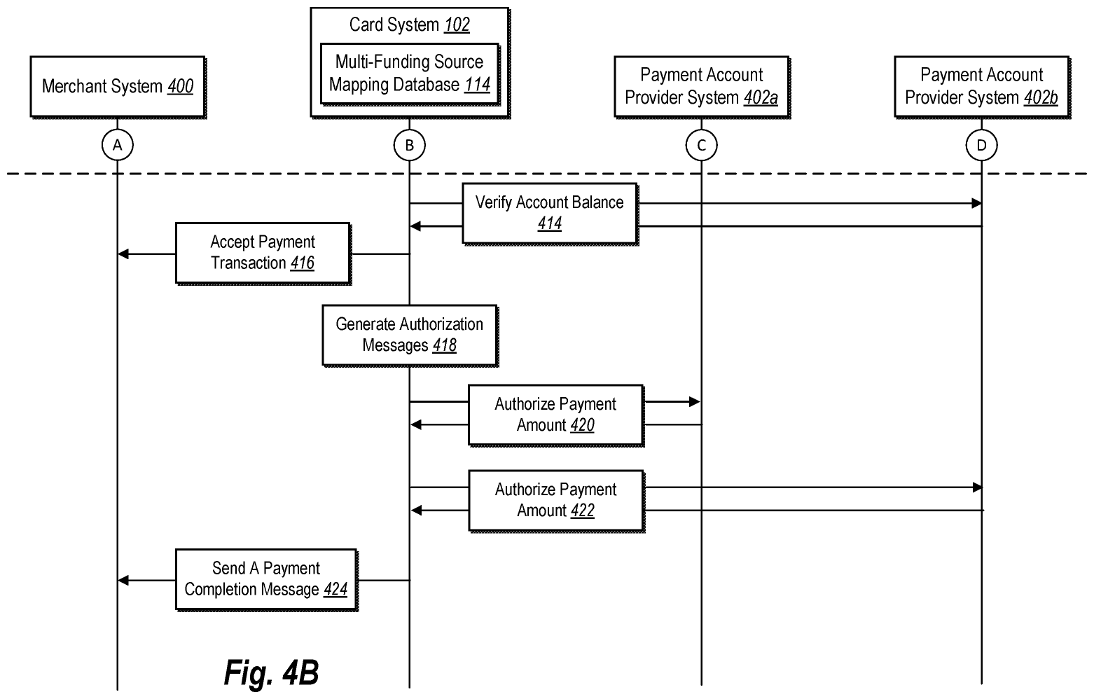

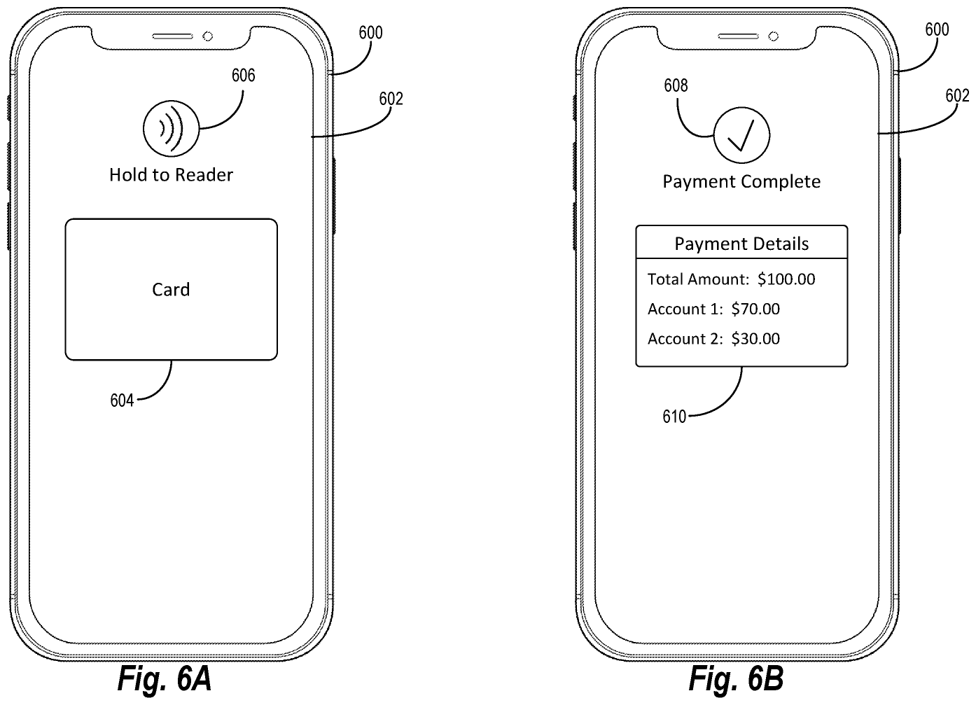

According to one or more embodiments, the card system 102 utilizes the account mapping and the parameters 204 to process a first multi-funding source transaction 206a with a first merchant system 208a. Specifically, as described in more detail with respect to FIGS. 4A-4B and FIGS. 6A-6B, the card system 102 processes the first multi-funding source transaction 206a by funding a payment from the card account 200 to the first merchant system 208a via the first payment account 202a and the second payment account 202b. Additionally, FIG. 2 illustrates that the card system 102 utilizes the account mapping and the parameters 204 to determine whether and how to process a second multi-funding source transaction 206b with a second merchant system 208b.

As mentioned, FIG. 3 illustrates that the card system 102 generates an account mapping for a card to link the card to one or more payment accounts. In particular, FIG. 3 illustrates that a client device 300 communicates with the card system 102 (e.g., via a client application 302) to perform a plurality of operations in connection with setting up a card. For example, as FIG. 3 illustrates, the client device 108 performs an act 304 of setting up a card for multi-funding source transactions. Specifically, a user of the client device 300 can interact with the client application 302 to request that the card system 102 create a card account (or otherwise create an account mapping) within the multi-funding source mapping database 114. In one or more embodiments, the request to set up the card includes information associated with the client device 300, such as a unique device identifier, a user identifier, an application identifier, or other identifier for associating with the card.

In response to the request to set up a card, the card system 102 establishes the card. In particular, as illustrated in FIG. 3, the card system 102 performs an act 306 of generating a card identification number representing the card. For instance, the card system 102 communicates with a card network or other system to generate the card identification number. To illustrate, the card system 102 generates the card identification number The card system 102 stores the card identification number with the card account, such as by associating the card identification number with the unique device identifier, user identifier, and/or other identifiers. In some embodiments, the card system 102 also creates authentication information associated with the card, such as a username and password or a PIN based on user input.

In one or more embodiments, as illustrated in FIG. 3, the client device 300 also performs an act 308 of selecting funding sources for the card. For example, the client device 300 (e.g., in response to a user interaction via the client application 302) determines a plurality of payment accounts for linking to the card identification number in the multi-funding source mapping database 114. To illustrate, the client device 300 provides indications of a plurality of payment accounts in response to a plurality of selections of payment accounts by a user. In one or more embodiments, the client device 300 displays options for entering or defining payment accounts utilizing payment credentials or account login information. Additionally, the client device 300 communicates with the card system 102 to indicate the selected funding sources (e.g., payment accounts) to the card system 102 for linking to the card identification number of the card.

In some embodiments, as previously mentioned, the card system 102 is able to connect a variety of different payment accounts to a card. For instance, the card system 102 determines one or more payment accounts, such as credit card accounts, debit card accounts, checking accounts, or demand deposit accounts. To illustrate, the card system 102 determines (e.g., in response to information provided from or via the client device 300) that a first selected payment account includes a credit card account associated with a user. Additionally, the card system 102 can also determine that a second selected payment account includes a checking account associated with the user or a different user.

In alternative embodiments, the card system 102 determines any combination of payment accounts and payment account types. For example, the card system 102 determines selected payment accounts including a plurality of payment accounts of a single payment account type (e.g., two credit card accounts). In another example, the card system 102 determines one or more payment accounts of a plurality of different payment account types (e.g., two credit card accounts and a demand deposit account). Accordingly, the card system 102 provides customizable combinations of payment accounts for linking to a card.

FIG. 3 further illustrates that the client device 300 performs an act 310 of selecting funding proportions. Specifically, funding proportions indicate portions of one or more multi-funding source transactions to attribute to the payment accounts associated with a card. For instance, the client device 300 displays options for selecting one or more proportions for one or more payment accounts. The client device 300 then provides indications of the selected funding proportions to the card system 102 in response to one or more user interactions via the client device 300.

According to one or more embodiments, the card system 102 determines proportions based on selected percentages for the payment accounts. To illustrate, the selected funding proportions can indicate a percentage of one or more multi-funding source transactions involving the card to fund utilizing a specific payment account. In some embodiments, determining a percentage allows the card system 102 to determine a percentage for another payment account (e.g., for a card linked to two payment accounts). In some embodiments, the card system 102 utilizes a plurality of percentages to determine proportions for all payment accounts.

In additional embodiments, the card system 102 determines one or more proportions based on one or more fixed amounts. Specifically, the card system 102 receives a selection of one or more fixed amounts for one or more payment accounts corresponding to a card. By assigning a fixed amount to a payment account, the card system 102 can determine how much to fund a given multi-funding source transaction utilizing each payment account linked to the card. In some embodiments, the card system 102 utilizes a combination of one or more percentages and one or more fixed amounts to determine funding proportions for the payment accounts.

In one or more embodiments, as illustrated in FIG. 3, the client device 300 performs an act 312 of setting additional parameters for a card. In particular, the client device 300 can display a plurality of parameters of various parameter types to a user for configuring the card for use in multi-funding source transactions via the card system 102. For example, the client device 300 displays options for setting specific limitations or restrictions associated with use of the card. To illustrate, the client device 300 provides options for setting limitations on the use of the card based on a merchant, a merchant type, a location, a time, a season, a transaction type, or other parameters associated with multi-funding source transactions.

In additional embodiments, the client device 300 displays options for setting limitations or determining proportions according to characteristics of one or more payment accounts linked to the card. For instance, the options can include interest rates, rewards, or balances associated with one or more payment accounts. More specifically, by allowing a user to set usage limitations (e.g., via the client device 300) for a card based on payment account characteristics in addition to characteristics of multi-funding source transactions, the card system 102 can provide dynamic transaction processing for a variety of different users, payment accounts, merchants, and other scenarios.

According to one or more embodiments, in response to receiving information associated with linking and using a card, the card system 102 verifies the information for processing multi-funding source transactions. In particular, as illustrated in FIG. 3, the card system 102 performs an act 314 of verifying funding sources for the card. For example, the card system 102 communicates with one or more payment account provider systems to determine whether payment accounts are valid and/or compatible with multi-funding source transactions. To illustrate, the card system 102 verifies a plurality of payment accounts by authorizing or authenticating the payment account information (e.g., payment credentials) with corresponding payment account provider systems. In some embodiments, the card system 102 also performs a fraud analysis on the payment accounts (e.g., based on client device data, login information, age of accounts, location, frequency/recency of requests by a client device to set up cards) to determine whether the card corresponds to legitimate funding sources and prevent fraudulent payment transactions.

In one or more embodiments, as illustrated in FIG. 3, the card system 102 also performs an act 316 of generating an account mapping for a card. Specifically, in response to verifying a plurality of payment accounts for funding multi-funding source transactions with the card, the card system 102 generates the account mapping to link the card identification number associated with the card to a plurality of payment accounts. To illustrate, the card system 102 generates a first mapping between the card identification number and a first payment account, a second mapping between the card identification number and a second payment account, etc., within the multi-funding source mapping database 114.

Furthermore, in one or more embodiments, the card system 102 stores funding proportions and any additional parameters with an account mapping for a card. For instance, the card system 102 stores the funding proportions and additional parameters in one or more entries/values associated with the card identification number of the card and/or one or more payment accounts in the multi-funding source mapping database 114. The card system 102 can thus store any limitations or other information for processing multi-funding source transactions utilizing the card in the multi-funding source mapping database 114.

In at least some embodiments, the card system 102 modifies a card based on additional user input. For example, as FIG. 3 illustrates, the client device 300 performs an act 318 of changing account settings for a card. To illustrate, the client device 300 can provide tools or options for adding or removing payment accounts in connection with a card. Additionally, the client device 300 can also provide options to modify the funding proportions and/or additional parameters associated with the card. Thus, the card system 102 can add a payment account, remove a payment account, modify a funding proportion for one or more payment accounts, or modify when and where a card can be used to process multi-funding source transactions after an initial configuration of the card.

As illustrated in FIG. 3, in response to receiving an indication of one or more settings to change for a card, the card system 102 performs an act 320 of modifying the account mapping for the card. In one or more embodiments, the card system 102 modifies the account mapping within the multi-funding source mapping database 114 in connection with the card identification number of the card. To illustrate, the card system 102 modifies the account mapping by adding a link between the card identification number and an additional payment account, removing an existing link between the card identification number and a removed payment account, or modifying other information associated with the card identification number based on the data provided by the client device 300.

Although FIG. 3 illustrates a specific order in which the client device 300 and card system 102 perform operations, the client device 300 and/or the card system 102 can perform the operations in a different order. For example, rather than generating the card identification number prior to selection of funding sources, the card system 102 generates the card identification number at another point in the card creation process (e.g., after verifying the funding sources). Accordingly, the card system 102 may create the card identification number after verifying the validity of payment accounts given the funding proportions and additional parameters and prior to generating an account mapping for the card.

In one or more embodiments, the card system 102 utilizes cards to process multi-funding source transactions with merchant systems. FIGS. 4A-4B illustrate sequence-flow diagrams in which the card system 102 utilizes a card mapped to a plurality of payment accounts to process a multi-funding source transaction. In particular, FIGS. 4A-4B illustrate that the card system 102 processes a multi-funding source transaction involving a merchant system 400 and a plurality of funding payment accounts associated with a plurality of payment account provider systems (i.e., a first payment account provider system 402a and a second payment account provider system 402b).

As illustrated in FIG. 4A, a merchant system 400 performs an act 404 of sending a request message for a payment transaction. Specifically, the merchant system 400 generates the request message in response to a client device interacting with the merchant system 400 to initiate the payment transaction. For example, the merchant system 400 includes a point-of-sale device or an application or website capable of engaging in electronic payment transactions with client devices of customers. To illustrate, the merchant system 400 utilizes a card terminal or other computing device to communicate with a mobile phone via near-field communication or wireless technologies. In one or more embodiments, the merchant system 400 includes a business or other entity that provides goods or services to customers via purchase utilizing electronic payment transactions.

In one or more embodiments, the card system 102 determines that the payment transaction indicated in the request message corresponds to a multi-funding source transaction involving a plurality of payment accounts. In particular, as illustrated in FIG. 4A, the card system 102 performs an act 406 of determining a card identification number of a payment card based on the request message. For instance, the card system 102 obtains the card identification number from the request message received from the merchant system 400. In addition, the card system 102 can obtain additional information associated with the payment transaction from the request message, including, but not limited to, a transaction amount and a merchant identifier. In some embodiments, the request message also includes a client identifier or a client application identifier indicating details associated with the client device or client application used to initiate the payment transaction with the merchant system 400.

According to some embodiments, the card system 102 determines a card account corresponding to a card based on the card identification number. Specifically, the card system 102 utilizes the card identification number to perform a lookup in the multi-funding source mapping database 114. Based on previously generating a card account for the card identification number in the multi-funding source mapping database 114, the card system 102 determines the card account in response to performing the lookup. Additionally, in some embodiments, after determining the card identification number from the request message, the card system 102 determines a validity of the card identification number (e.g., via a card network or issuer of the card identification number).

In addition to determining the card account, the card system 102 also determines a plurality of parameters associated with the card identification number. In one or more embodiments, as illustrated in FIG. 4A, the card system 102 performs an act 408 of determining funding sources from an account mapping. For instance, the card system 102 accesses the account mapping corresponding to the card identification number to determine a plurality of payment accounts linked to the card identification number. To illustrate, the card system 102 determines a first payment account and a second payment account mapped to the card identification number in the card account. In some embodiments, the card system 102 determines payment credentials (e.g., card numbers or account numbers) for the payment accounts mapped to the card identification number.

In one or more embodiments, as illustrated in FIG. 4A, the card system 102 also performs an act 410 of determining funding proportions associated with the funding sources. Specifically, the card system 102 determines how to split a transaction amount of the payment transaction across a plurality of payment accounts. For example, the card system 102 determines whether to split the transaction amount according to one or more percentages (e.g., 50-50) or one or more fixed amounts (e.g., $30) assigned to one or more payment accounts in the card account. To illustrate, the card system 102 determines a first payment amount for a first payment account and a second payment amount for a second payment account according to the funding proportions.

Furthermore, in one or more embodiments, the card system 102 determines whether to process the payment transaction as a multi-funding source transaction utilizing the card account. To illustrate, in response to determining that the card identification number is mapped to a plurality of payment accounts and/or based on additional parameters associated with the card identification number, the card system 102 determines that the card account is compatible with multi-funding source transactions. For instance, the card system 102 determines that the card account indicates to process payment transactions of a particular transaction type, merchant type, or with specific transaction parameters as multi-funding source transactions.

In some embodiments, the card system 102 also utilizes the additional parameters associated with the card identification number to determine how to divide a transaction amount among a plurality of payment accounts. To illustrate, the card system 102 determines a first set of proportions for payment accounts in response to determining that the card account includes parameters indicating the first set of proportions for a payment transaction. For example, the card system 102 determines the first set of proportions based on parameters including, but not limited to, the transaction type, merchant system, month, location, rewards associated with the payment accounts, interest rates associated with the cards, or other account balances. Alternatively, the card system 102 determines a second set of proportions for payment accounts in response to determining that the card account includes parameters indicating the second set of proportions for a payment transaction (e.g., based on a different transaction type or merchant system).

In alternative embodiments, the card system 102 determines that the card account is not compatible with or does not qualify for multi-funding source transactions (or that the payment transaction does not qualify as a multi-funding source payment transaction with the card). For example, the card system 102 determines that the card account is not compatible with multi-funding source transactions based on a mapping of the card identification number to a single payment account or other parameters associated with the card account. To illustrate, the card system 102 determines not to process the payment transaction of the request message as a multi-funding source transaction in response to determining that a setting associated with the card account indicates not to process payment transactions of a particular transaction type, merchant type, or with specific transaction parameters as multi-funding source transactions. Accordingly, the card system 102 determines to process a payment transaction as a single-source transaction in response to determining that the card account is not compatible with processing the payment transaction as a multi-funding source transaction.

According to one or more embodiments, in response to determining funding proportions for funding sources, the card system 102 optionally verifies the payment transaction with one or more payment account provider systems. As illustrated in FIG. 4A, the card system 102 performs an act 412 of verifying an account balance for a first payment account with the first payment account provider system 402a. Additionally, as illustrated in FIG. 4B, the card system 102 performs an act 414 of verifying an account balance for a second payment account with the second payment account provider system 402b.

In one or more embodiments, the card system 102 verifies an account balance for each payment account by verifying that the payment account has sufficient funds to fund a corresponding payment amount/portion. To illustrate, the card system 102 can communicate with the first payment account provider system 402a and the second payment account provider system 402b to determine balance amounts, available credit, etc., associated with the payment accounts. Alternatively, the card system 102 maintains account balances for one or more payment accounts or data associated with the account balances to quickly verify account balances for one or more payment accounts.

As illustrated in FIG. 4B, the card system 102 performs an act 416 of accepting the payment transaction. In particular, the card system 102 notifies the merchant system 400 of the acceptance of the payment transaction in response to verifying the account balances for the payment accounts. Additionally, in one or more embodiments, the card system 102 also accepts the payment transaction based on parameters associated with the card account. For instance, the card system 102 determines whether to accept the payment transaction based on transaction parameters/characteristics meeting thresholds or requirements indicated by parameters of the card account. To illustrate, the card system 102 determines that the payment transaction meets a time, location, transaction type, or merchant requirement indicated by the parameters of the virtual account.

According to one or more embodiments, the card system 102 processes the payment transaction after accepting the payment transaction. For instance, as illustrated in FIG. 4B, the card system 102 performs an act 418 of generating authorization messages to authorize the payment transactions. Specifically, the card system 102 generates a first authorization message including an authorization request for the payment transaction against the first payment account according to a first proportion (e.g., a first payment amount). Furthermore, the card system 102 generates a second authorization message including an authorization request for the payment transaction against the second payment account according to a second proportion (e.g., a second payment amount).

In one or more embodiments, the card system 102 generates each authorization message to include a request to authorization according to the specific payment account. To illustrate, the card system 102 can generate the first authorization message according to a first authorization protocol for the first payment account and the second authorization message according to a second authorization protocol for the second payment account. As an example, the first authorization message includes a credit card authorization message to authorize the first proportion with a payment card network for funding by a credit card (e.g., according to PCI standards). Additionally, for example, the second authorization message includes a cryptocurrency authorization message to authorize the second proportion with a system that manages cryptocurrencies for funding by a cryptocurrency account. Thus, the card system 102 can generate each authorization message to include a structure and content specific to the type of payment account funding each proportion of the transaction.

According to one or more embodiments, the card system 102 also provides one or more authorization messages for one or more ledger accounts. For example, in response to determining that a ledger account associated with the card corresponds to a third-party system (e.g., an external system) that manages ledger accounts, the card system 102 can generate and send an authorization message to request authorization of funding via the ledger account to the third-party system. Alternatively, in response to determining that a ledger account associated with the card corresponds to an internal ledger system that manages ledger accounts (e.g., managed by the card system 102 or otherwise associated with the card system 102), the card system 102 can generate and send an authorization message to request authorization of funding via the ledger account to the internal ledger system.

As illustrated in FIG. 4B, in one or more embodiments, the card system 102 performs an act 420 of authorizing a payment amount associated with the first payment account. In particular, the card system 102 sends the first authorization message to the first payment account provider system 402a to authorize a transaction with the first payment account according to the payment amount. To illustrate, the card system 102 processes a first payment transaction with the first payment account with the first payment account provider system 402a for the first payment amount.

Additionally, as illustrated in FIG. 4B, the card system 102 performs an act 422 of authorizing a payment amount associated with the second payment account. Specifically, the card system 102 sends the second authorization message to the second payment account provider system 402b to authorize a transaction with the second payment account according to the payment amount. Although FIG. 4B illustrates that the first authorization message occurs before the second authorization message, the card system 102 can authorize the payment amounts for each of the payment accounts in parallel to reduce transaction processing time. The card system 102 can thus send a plurality of authorization messages for processing different payment amounts in parallel or in sequence according to various embodiments. Accordingly, the card system 102 processes a second payment transaction with the second payment account with the second payment account provider system 402b for the second payment amount. The card system 102 thus automatically separates a multi-funding source transaction into a plurality of separate transactions involving a plurality of payment accounts.

In connection with authorizing the payment transaction with the payment account provider systems, the card system 102 finishes processing the payment transaction. In one or more embodiments, the authorization messages to the payment account provider systems causes the payment account provider systems to transfer funds from the payment accounts to a payment account of the merchant system and/or to a payment account associated with the card system 102 (e.g., in a settlement process by the separate payment account provider systems). Specifically, the first payment account provider system 402a processes the first payment transaction to transfer funds from the first payment account to the payment account of the merchant system. Additionally, second payment account provider system 402b processes the second payment transaction to transfer funds from the second payment account to the payment account of the merchant system.

In some embodiments, the card system 102 utilizes Just-In-Time (“JIT”) funding to fund a multi-funding source transaction. For example, the card system 102 can communicate with the payment account provider systems 402a-402b utilizing JIT funding messages to fund and authorize multi-funding source transactions in real-time. To illustrate, the card system 102 sends a JIT funding message to a payment account provider system (e.g., the first payment account provider system 402a) to obtain program reserve funding (e.g., via clearing house or wire transfer) to fund a portion of a multi-funding source transaction. In alternative embodiments, the card system 102 provides the JIT funding message directly to a user device if the user manages the balance of the corresponding payment account. In additional embodiments, the card system 102 utilizes blockchain transactions, automated clearing house transfers, or real-time transport protocol transactions to transfer funds from one account to another.

In some embodiments, the card system 102 processes the payment transaction in response to receiving confirmation of authorization of the payment amounts for the payment accounts associated with the card identification number. For example, the card system 102 only completes the payment transaction in response to successful authorization of all payment amounts for all payment accounts. Thus, the card system 102 can prevent situations in which one payment account fails authorization and another payment account passes authorization. In alternative embodiments, the card system 102 performs a pre-authorization request for each payment account prior to sending the authorization messages (e.g., by obtaining pre-authorization when verifying account balances). In additional embodiments, the card system 102 performs the account balance verification and authorization operations for each payment account in a single request (or batch of requests).

According to some embodiments, the card system 102 determines one or more backup transaction processes for cases in which one or more funding sources fails. To illustrate, in response to determining that a payment account does not have sufficient funds or does not have permissions to fund a corresponding proportion of a multi-funding source transaction, the card system 102 can select one or more alternative funding sources to fund the corresponding proportion. For instance, the card system 102 can automatically determine a backup funding source according to established preferences of the card (e.g., a default backup funding source) and utilize the backup funding source to fund the proportion. In some embodiments, the card system 102 determines a backup funding source based on a plurality of possible backup funding sources for a particular scenario (e.g., a first backup funding source for a first transaction type or a second backup funding source for a second transaction type). Additionally, the card system 102 can also adjust one or more proportions in response to replacing a rejected funding source with one or more backup funding sources.

In additional embodiments, the card system 102 provides a notification to an owner or managing user of the card in response to a funding failure with one or more options for selecting a backup funding source for the transaction. The card system 102 can determine one or more selected backups funding source based on a selection of the one or more backup funding sources by the user. The card system 102 can then continue processing the transaction utilizing the one or more selected backup funding sources. In response to determining that a card does not have a backup funding source in case of a failure, the card system 102 may alternatively reject the payment transaction.

In one or more embodiments, the card system 102 also determines whether one or more parameters of one or more funding sources in the transaction prevent the transaction from being processed as a multi-funding source transaction. For example, the card system 102 can determine that one or more payment accounts associated with the card do not have sufficient funds, have card controls preventing the one or more payment accounts from being used with the transaction, or otherwise cannot be used to process the transaction. The card system 102 may also determine that one or more backup funding sources do not allow for processing the transaction with multiple funding sources. Accordingly, in response to determining that one or more of the payment accounts is not compatible with a multi-funding source transaction, the card system 102 converts the payment transaction to a single funding source transaction and processes the transaction with a single payment account (e.g., with a primary/default account).

In one or more embodiments, the card system 102 generates one or more notifications that the payment transaction processed. In particular, as illustrated in FIG. 4B, the card system 102 performs an act 424 of sending a payment completion message to the merchant system 400. For instance, in response to receiving confirmations of authorizations of the payment amounts for the payment accounts, the card system 102 generates a payment completion message including an indication of the successful authorization and processing of the payment transaction. In some embodiments, the card system 102 generates the payment completion message to include details associated with the payment transaction, such as the payment amount and the merchant identifier. Furthermore, because the card system 102 utilizes the card identification number to process the transaction from the perspective of the merchant system 400, the merchant system 400 does not have access to the payment credentials of the payment accounts.

In additional embodiments, the card system 102 provides one or more messages to one or more client devices associated with the card identification number in connection with processing the payment transaction. For example, the card system 102 generates a payment completion message including transaction information for providing to a client device that initiated the payment transaction with the merchant system 400. To illustrate, the card system 102 provides a payment completion message including the transaction amount, a plurality of payment accounts used to fund the payment transaction, and separate payment amounts corresponding to the different payment accounts.

In one or more embodiments, the card system 102 generates a merchant identifier to indicate that the payment transaction is processed utilizing a card. For example, the card system 102 generates a separate merchant identifier that indicates that the card and the merchant system 400 were involved in processing the payment transaction. The card system 102 can store the merchant identifier with the payment transaction for easily identifying the merchant system and the card system in a transaction history for a payment account or for the card identification number. To illustrate, the card system 102 can generate the merchant identifier based on a name corresponding to the merchant system 400 and/or a name corresponding to the card system 102.

Although FIGS. 4A-4B illustrate the card system 102 processing a multi-funding source transaction according to a particular configuration of payment accounts and payment account provider systems, the card system 102 can process transactions with other configurations. For instance, the card system 102 can process transactions involving more payment accounts (e.g., three, four, or more). Additionally, the card system 102 can process transactions by communicating with any number of payment account provider systems. To illustrate, the card system 102 can communicate with a single payment account provider system in connection with a plurality of payment accounts involved in a multi-funding source transaction, depending on bank systems associated with the payment accounts.

As mentioned, the card system 102 provides tools for creating and configuring a card for use in multi-funding source transactions. Specifically, the card system 102 provides tools for linking a card to a plurality of payment accounts and setting proportions and other parameters for determining how to process payment transactions with the card. FIGS. 5A-5E illustrate a plurality of graphical user interfaces of a client device 500 including a client application 502 for creating and managing a card.

FIG. 5A illustrates the client device 500 (e.g., a mobile device) displaying a graphical user interface of the client application 502 in connection with creating a card. For example, the client application 502 includes a digital wallet application or a digital card management application that includes a plurality of tools for creating, accessing, viewing, or otherwise managing a card of one or more users. In one or more embodiments, the client device 500 provides tools for generating a card, assigning payment accounts to the card, establishing parameters for the card, and utilizing the card to engage in payment transactions.

According to one or more embodiments, as illustrated in FIG. 5A, the client device 500 provides options for configuring a card. To illustrate, the client device 500 displays a card icon 504 representing the card. In some embodiments, the card icon 504 includes a name, card identification number (or partial card identification number) or other identifier for identifying the card. The client device 500 can also provide options for switching between cards (e.g., for users that have more than one virtual or digital card on their device).

As illustrated in FIG. 5A, the client device 500 also displays information for a plurality of payment accounts. Specifically, the client device 500 displays an account section 506 including a plurality of accounts mapped to the card. For example, the account section 506 includes payment account identifiers (e.g., names, issuers), type of account, payment account credentials/numbers (e.g., partial masked 16-digit numbers), etc. In some embodiments, the account section 506 also includes an owner of each payment account, such that a user of the client device 500 can easily determine an identity of each payment account and who has control over the various payment accounts. The client device 500 can also display an option to remove or modify a payment account linked to the card.

According to one or more embodiments, the client device 500 also displays an account element 508 for adding new accounts to the card and a settings element 510 for configuring the card. In particular, in response to a selection of the account element 508, the client device 500 navigates to a new interface for adding one or more additional payment accounts to the card. To illustrate, FIG. 5B and the corresponding description below provide additional detail related to adding payment accounts to a card. In response to a selection of the settings element 510, the client device 500 navigates to a new interface for establishing proportions and/or additional parameters associated with the card or payment accounts. For example, FIG. 5C and the corresponding description below provide additional detail related to configuring additional parameters associated with a card.

As mentioned, FIG. 5B illustrates a graphical user interface of the client device 500 for adding a payment account associated with a card. Specifically, in response to a selection of an option to add a payment account to a card (e.g., the account element 508 of FIG. 5A), the client device 500 navigates to the graphical user interface of FIG. 5B. In one or more embodiments, the client device 500 displays one or more options to add one or more payment accounts of various account types. To illustrate, the client device 500 provides options to add credit/debit card accounts, cryptocurrency accounts, or deposit accounts (e.g., checking accounts, stored value accounts, or other demand deposit accounts).

For instance, in response to a selection of a card account option 512, the client device 500 displays elements for providing relevant information for adding a credit/debit card account. More specifically, FIG. 5B illustrates that the client device 500 displays elements for entering a card account number (e.g., a 16-digit number), a card type (e.g., an issuer of the credit/debit card account), an expiration date, and a card verification value. In additional embodiments, selecting one of the other options (e.g., the cryptocurrency account option or deposit account option) causes the client device 500 to display different information relevant to the specific type of card account being added. For instance, for adding a deposit account, the client device 500 can display an option to enter an account number and a routing number or a login screen for entering login information for a deposit account. Alternatively, for adding a cryptocurrency account, the client device 500 can display a login screen for entering login information for a cryptocurrency account. In some embodiments, the client device 500 redirects to a separate website, application, or interface for entering the payment account information.

The client device 500 provides the entered information to the card system 102 to verify the payment account information and add the payment account to the card. For example, the client device 500 displays an add element 514 to verify payment account information, login information or other information entered via the client device 500. The client device 500 can communicate with a payment account provider system (e.g., based on the payment account provider system being integrated with the card system 102 an API provided by the card system 102) to verify the payment account information and add the payment account to the card. Additionally, in response to verifying and adding a payment account, the card system 102 links the payment account to the card by mapping the payment account information to a card identification number of the payment card.

To illustrate, the card system 102 can create and manage an API that exposes a plurality of interaction operations to third-party systems such as the payment account provider system. The payment account provider system can integrate with the card system 102 via the API to allow the card system 102 to access data associated with payment accounts. In one or more embodiments, the payment account provider system integrates with the card system 102 via the API in response to a request to establish a payment account associated with the card system 102 via the payment account provider system. Additionally, the card system 102 can utilize the integration of the payment account provider system via the API to notify the payment account provider system of a link to a card identification number, verify an account balance, access an account history, or other data or operations associated with a payment account.

FIG. 5C illustrates a graphical user interface of the client device 500 for establishing additional parameters associated with a card. Specifically, the client device 500 provides a plurality of options for setting proportions associated with a plurality of payment accounts linked to the card. For instance, the client device 500 displays a percentage option 516 for setting a percentage associated with a payment account or a fixed amount option 518 for setting a fixed amount associated with the payment account.

In one or more embodiments, the percentage option 516 includes a dropdown menu from which a user can select one of a plurality of different percentages. To illustrate, the percentage option 516 displays percentages in specific increments, such as 1% increments, 5% increments, 10% increments, etc. Alternatively, the client device 500 displays an option for manually entering the percentage via numerical text in a text entry field. In response to a selection of a percentage for a payment account, the client device 500 displays the selected percentage.

Additionally, in some embodiments, the client device 500 utilizes a selection of one or more percentage options of one or more payment accounts to determine percentages associated with one or more additional payment accounts. For example, in response to a selection of a percentage for a first payment account and based on determining that two payment accounts are linked to a card, the client device 500 determines a percentage of a second payment account. More specifically, the client device 500 automatically determines the percentage for the second payment account by subtracting the percentage for the first payment account from 100%. In other embodiments, the client device 500 utilizes a selection of a percentage for each separate payment account. In some instances, the client device 500 provides a default percentage value of equal percentages for the plurality of payment accounts.

In additional embodiments, as mentioned, the client device 500 provides the fixed amount option 518 for setting a fixed amount for a payment account. In particular, entering a fixed amount for a particular payment amount indicates that the card system 102 determines a proportion for the payment account to fund a payment transaction up to the fixed amount. Accordingly, the card system 102 funds any remaining payment amounts for the payment transaction utilizing one or more other payment accounts. In some embodiments, the client device 500 displays an error in response to determining that entered percentages, fixed amounts, or other proportions do not allow for complete funding of payment transactions.

In one or more embodiments, although not shown, the card system 102 determines proportions according with one or more payment accounts linked to a card based on additional parameters. For example, the client device 500 can provide elements for entering various combinations of total payment amounts for payment accounts, time periods associated with particular proportions, merchants associated with particular proportions, account interest rates, account rewards, and/or other parameters that can affect proportions funded by the payment accounts. Additionally, the client device 500 can determine, based on user input, settings to fund a first fixed amount of multi-funding source transactions with a first set of proportions and a second set of proportions after reaching the first fixed amount (e.g., funding 100% of the first $200 in a month with a first payment account and then splitting additional amounts equally between a plurality of amounts after the first $200, or vice-versa). Accordingly, the client device 500 can provide tools for dynamically modifying the funding proportions of the payment accounts according to different scenarios of multi-funding source payment transactions.

In some instances, the client device 500 also provides an option for real-time determination of funding proportions of payment accounts for a card. For instance, the card system 102 can communicate with one or more systems (e.g., card networks or issuing systems) to determine interest rates or account rewards on a daily basis (or other incremental time period). The card system 102 can use the periodically updated information to determine the funding proportions for that day (or time period). The card system 102 can thus provide opportunities for real-time (or near real-time) dynamic proportion adjustments for processing payment transactions.

In one or more embodiments, the card system 102 provides notifications to owners of payment accounts based on changes made to the card. To illustrate, in response to generating a mapping between the card and a payment account, the card system 102 notifies an owner of the payment account (e.g., via a client device of the owner of the payment account). Additionally, the card system 102 can notify owners of payment accounts in response to other actions, such as changes to proportions assigned to the payment accounts linked to the card or allowed/disallowed recipients.

In further embodiments, the card system 102 provides customizability over when and how a card can be involved in payment transactions (or multi-funding source transactions). To illustrate, as shown in FIG. 5C, the client device 500 displays a recipients element 520 for selecting recipients for which the card is valid. In one or more additional embodiments, the client device 500 provides an additional settings element 522 for configuring additional parameter settings for customizing use of the card, such as by adding additional restrictions, limitations, or thresholds associated with the card. Additionally, FIG. 5C illustrates a save element 524 to save the selected proportions and additional parameters associated with the card. For example, the client device 500 provides the proportions and additional settings to the card system 102 to store with an account mapping for the card.

As mentioned, the client device 500 provides options to select specific recipients for the card. FIG. 5D illustrates that the client device 500 displays a graphical user interface for adding specific merchants or other recipients to one or more lists of valid or invalid recipients. Specifically, in response to a selection of the recipients element 520 of FIG. 5C, the client device 500 can display an interface by which a user can enter or select one or more merchant systems or merchant types for which the card is valid. To illustrate, the client device 500 displays an allow list option 526 for adding one or more recipients to an allow list. Additionally, the client device 500 displays a block list option 528 for adding one or more recipients for determining merchant systems or merchant types for which the card is not valid. For example, the client device 500 displays a block list option 528 for adding one or more recipients to a block list.

Furthermore, as illustrated in FIG. 5D, the client device 500 displays an entry field 530 for adding new recipients to an allow list or to a block list. For example, the client device 500 can detect text entered into the entry field 530 and associate the text with a particular recipient. In one or more embodiments, the card system 102 utilizes the text to determine a merchant or other known recipient utilizing a lookup database—such as based on a recipient name in a user's contacts, based on nearby locations, etc. In other embodiments, the card system 102 utilizes the text to allow or disallow based on an exact comparison of the entered text to a recipient identifier in a request message to initiate a payment transaction. After determining the recipient, the client device 500 displays a recipient identifier 532 within the allow list or block list. The client device 500 can also remove the recipient identifier 532 in response to a request to remove the recipient from the allow list or block list (e.g., in response to a selection of a remove element within the graphical user interface).

Additionally, in response to a selection of the additional settings element 522 of FIG. 5C, the client device 500 can display an interface by which a user can enter or select one or more additional limitations associated with payment transactions for which the card is valid or not valid. For example, as illustrated in FIG. 5E, the client device 500 displays options for selecting a variety of additional restrictions or parameters that determine how to process multi-funding source transactions for the card. In one or more embodiments, the additional parameters include, but are not limited to, locations, transaction types, dates, times, total payment amounts, account balances, or other characteristics that the card system 102 can use in validating the card for a payment transaction.

To illustrate, as shown in FIG. 5E, the client device 500 displays an date/time option for selecting specific dates or times in which the card is valid for processing payment transactions. In particular, the client device 500 displays a calendar element 534 that causes the client device 500 to display a calendar. In one or more embodiments, the client device 500 determines specific dates or times based on user selections of the specific dates or times via the calendar. To illustrate, the client device 500 can determine specific times during a day or week for which the card is valid or invalid for initiating payment transactions. The client device 500 can also determine specific dates (e.g., specific holidays or other dates) for which the card is valid or invalid for initiating payment transactions. In some embodiments, the client device 500 also determines specific seasons (e.g., ranges of time periods) for which the card is valid or invalid for initiating payment transactions.

FIG. 5E also illustrates that the client device 500 displays a location option for selecting specific locations for which the card is valid or invalid for initiating payment transactions. Specifically, the client device 500 displays an entry field 536 by which a user can enter a location (e.g., a city or zip code) in which the card is valid for initiating payment transactions. The card system 102 can verify an entered location and, in response to verifying the location, insert a location element 538 indicating the verified location. Thus, the client device 500 can allow a user to specify one or more specific locations for which the card is valid for initiating transactions while prohibiting use of the card outside the specified locations.

Once the card system 102 has created a card and linked the card to a plurality of payment accounts in an account mapping with funding proportions (and additional parameters, if applicable), the card system 102 utilizes the account mapping to process multi-funding source transactions involving the card. FIGS. 6A-6B illustrate an example of graphical user interfaces for processing a multi-funding source transaction utilizing a card. Specifically, FIGS. 6A-6B illustrate a client device 600 including a client application 602 for initiating a payment transaction utilizing a card that is mapped to a plurality of payment accounts.

FIG. 6A illustrates that the client device 600 displays a graphical user interface including an indicator 606 representing an option to initiate an electronic payment transaction via a near-field communication. For example, the client device 600 can display the graphical user interface with the indicator 606 in response to a request to perform an electronic payment transaction with a merchant system or other recipient. To illustrate, the client device 600 can display the indicator 606 with a message to hold the client device 600 next to a reader device, such as a point-of-sale device, to initiate the payment transaction.

Additionally, as shown in FIG. 6A, the client device 600 displays a card icon 604 representing a card stored at (or otherwise associated with) the client device 600. In one or more embodiments, the client device 600 displays a plurality of cards in a digital wallet associated with the client device 600 for use in initiating electronic payment transactions. The client device 600 can select the card from the plurality of cards in response to a selection of the card. In alternative embodiments, the client device 600 displays the card icon 604 based on the card being selected as a default payment option for electronic payment transactions.

FIG. 6B illustrates a graphical user interface of the client device 600 after processing a payment transaction involving a card. Specifically, the card system 102 can determine that a multi-funding source transaction involving a plurality of payment accounts mapped to the card successfully processed. In one or more embodiments, the card system 102 provides information to the client device 600 indicating that the payment transaction processed successfully. For example, as illustrated in FIG. 6B, the client device 600 displays completion indicator 608 indicating that the card system 102 successfully processed the payment transaction via the reader device of the recipient.

In one or more additional embodiments, the client device 600 also displays a payment completion message 610 in response to completion of the payment transaction. In particular, in response to receiving an indication of successful completion of the payment transaction from the card system 102, the client device 600 can display the payment completion message 610 including details associated with the payment transaction. For instance, the payment completion message 610 can include a total transaction amount associated with the payment transaction.

The payment completion message 610 can also include separate payment amounts charged to the payment accounts mapped to the card. To illustrate, the payment completion message 610 can include a first payment amount charged to a first payment account linked to the card and a second payment amount charged to a second payment account linked to the card. In one or more embodiments, the card system 102 processes the payment transaction based on proportions for the separate payment accounts as indicated with the account mapping for the card. In additional embodiments, the payment completion message 610 also includes other information, such as a recipient identifier (e.g., a recipient name), time data, location data, and/or a reason associated with the purchase.

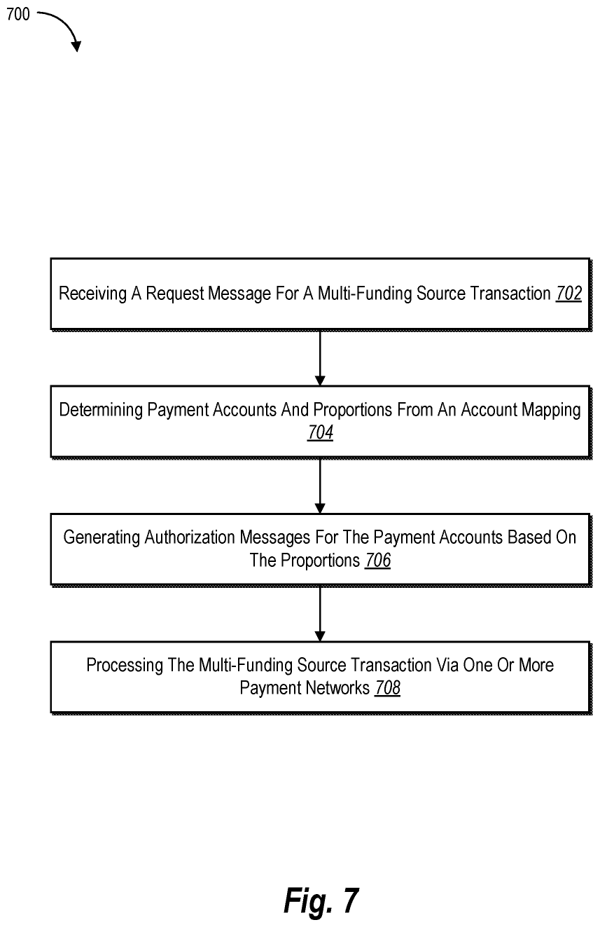

Turning now to FIG. 7, this figure shows a flowchart of a series of acts 700 of processing a multi-funding source payment transaction involving a plurality of funding payment accounts. While FIG. 7 illustrates acts according to one embodiment, alternative embodiments may omit, add to, reorder, and/or modify any of the acts shown in FIG. 7. The acts of FIG. 7 can be performed as part of a method. Alternatively, a non-transitory computer readable medium can comprise instructions, that when executed by one or more processors, cause a computing device to perform the acts of FIG. 7. In still further embodiments, a system can perform the acts of FIG. 7.

As shown, the series of acts 700 includes an act 702 of receiving a request message for a multi-funding source transaction. For example, act 702 involves receiving, from a merchant system, a request message comprising a transaction amount and a card identification number associated with a multi-funding source transaction. Act 702 can involve receiving the request message based on a client device initiating the multi-funding source transaction with the merchant system utilizing a card associated with the card identification number.

Furthermore, the series of acts 700 includes an act 704 of determining payment accounts and proportions from an account mapping. For example, act 704 involves determining, from an account mapping for the card identification number in an account mapping database, a plurality of proportions corresponding to a plurality of payment accounts, the plurality of proportions comprising a first proportion corresponding to a first payment account and a second proportion corresponding to a second payment account.

Act 704 can involve determining that the account mapping for the card identification number links the card identification number to the first payment account and the second payment account. Act 704 can also involve determining the first proportion and the second proportion based on the account mapping and the transaction amount.

For example, act 704 can involve accessing, from a multi-funding source mapping database, the account mapping based on the card identification number. Act 704 can involve determining the first proportion based on the transaction amount and a first percentage corresponding to the first payment account in the account mapping. Act 704 can also involve determining the second proportion based on the transaction amount and a second percentage corresponding to the second payment account in the account mapping.

Act 704 can alternatively involve determining the first proportion as a fixed amount based on the account mapping. Act 704 can also involve determining the second proportion based on a difference between the fixed amount and the transaction amount.

Act 704 can involve determining a plurality of attributes associated with the multi-funding source transaction and the merchant system. For example, act 704 can involve determining a plurality of attributes comprising a merchant type, a merchant location, or a transaction time associated with the multi-funding source transaction and the merchant system. Act 704 can involve determining a validity of the multi-funding source transaction for the card identification number based on the plurality of attributes. Act 704 can also involve determining the first proportion and the second proportion based on the plurality of attributes or based on the validity of the multi-funding source transaction.

The series of acts 700 also includes an act 706 of generating authorization messages for the payment accounts based on the proportions. For example, act 706 involves generating, based on the transaction amount, a first authorization message comprising an authorization request for the multi-funding source transaction against the first payment account according to the first proportion. Additionally, act 706 involves generating, based on the transaction amount, a second authorization message comprising an authorization request for the multi-funding source transaction against the second payment account according to the second proportion.

Act 706 can involve generating the first authorization message in response to verifying an account balance associated with the first payment account. Additionally, act 706 can involve generating the first authorization message comprising a first amount based on the first proportion and a transaction identifier based on the card identification number and the merchant system. Act 706 can also involve generating the second authorization message in response to verifying an account balance associated with the second payment account. Act 706 can further involve generating the second authorization message comprising a second amount based on the second proportion and the transaction identifier based on the card identification number and the merchant system.

Act 706 can involve generating the first authorization message according to a first account type associated with the first payment account. Act 706 can also involve generating the second authorization message according to a second account type associated with the second payment account, the first account type being different from the second account type.

Additionally, the series of acts 700 includes an act 708 of processing the multi-funding source transaction via one or more payment networks. For example, act 708 involves processing the multi-funding source transaction by sending the first authorization message and the second authorization message to one or more payment networks. Act 708 can involve sending the first authorization message to a first payment account provider system and the second authorization message to a second payment account provider system. Act 708 can involve providing the first authorization message and the second authorization message to the one or more payment networks in parallel. Alternatively, act 708 can involve providing the first authorization message and the second authorization message to the one or more payment networks in sequence.

The series of acts 700 can also include generating the account mapping for the card identification number. For example, the series of acts 700 can include authenticating, via the one or more payment networks, the first payment account according to first account credentials associated with a first account type. The series of acts 700 can also include authenticating, via the one or more payment networks, the second payment account according to second account credentials associated with a second account type different from the first account type. Additionally, the series of acts 700 can include generating the account mapping for the card identification number in response to authenticating the first payment account and authenticating the second payment account.

The series of acts 700 can further include determining one or more account parameters associated with the first payment account or the second payment account. The series of acts 700 can also include linking the first payment account and the second payment account to the card identification number within the account mapping according to the one or more account parameters.

The series of acts 700 can also include generating, in response to processing the multi-funding source transaction, a transaction completion message comprising the transaction amount, a first payment amount corresponding to the first payment account, and a second payment amount corresponding to the second payment account. The series of acts 700 can further include sending the transaction completion message to one or more client devices associated with the card identification number. For example, the series of acts 700 can include sending a first transaction completion message to a client device that initiated the multi-funding source transaction. The series of acts 700 can also include sending a second transaction completion message to an additional client device associated with the first payment account or the second payment account.

In one or more embodiments, the series of acts 700 includes receiving, from an additional merchant, an additional request message comprising the card identification number associated with a payment transaction. The series of acts 700 can include determining a plurality of attributes associated with the payment transaction and the additional merchant system. The series of acts 700 can further include determining, based on the plurality of attributes, that the payment transaction does not qualify as a multi-funding source payment transaction. The series of acts 700 can include processing via the one or more payment networks, the payment transaction utilizing the first payment account.

The series of acts 700 can include updating, in response to a request, the account mapping to link a third payment account to the card identification number. The series of acts 700 can also include modifying transaction parameters associated with the account mapping based on the first payment account, the second payment account, and the third payment account.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 8 illustrates a block diagram of exemplary computing device 800 that may be configured to perform one or more of the processes described above. One will appreciate that one or more computing devices such as the computing device 800 may implement the system(s) of FIG. 1. As shown by FIG. 8, the computing device 800 can comprise a processor 802, a memory 804, a storage device 806, an I/O interface 808, and a communication interface 810, which may be communicatively coupled by way of a communication infrastructure 812. In certain embodiments, the computing device 800 can include fewer or more components than those shown in FIG. 8. Components of the computing device 800 shown in FIG. 8 will now be described in additional detail.

In one or more embodiments, the processor 802 includes hardware for executing instructions, such as those making up a computer program. As an example, and not by way of limitation, to execute instructions for dynamically modifying workflows, the processor 802 may retrieve (or fetch) the instructions from an internal register, an internal cache, the memory 804, or the storage device 806 and decode and execute them. The memory 804 may be a volatile or non-volatile memory used for storing data, metadata, and programs for execution by the processor(s). The storage device 806 includes storage, such as a hard disk, flash disk drive, or other digital storage device, for storing data or instructions for performing the methods described herein.

The I/O interface 808 allows a user to provide input to, receive output from, and otherwise transfer data to and receive data from computing device 800. The I/O interface 808 may include a mouse, a keypad or a keyboard, a touch screen, a camera, an optical scanner, network interface, modem, other known I/O devices or a combination of such I/O interfaces. The I/O interface 808 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 808 is configured to provide graphical data to a display for presentation to a user. The graphical data may be representative of one or more graphical user interfaces and/or any other graphical content as may serve a particular implementation.

The communication interface 810 can include hardware, software, or both. In any event, the communication interface 810 can provide one or more interfaces for communication (such as, for example, packet-based communication) between the computing device 800 and one or more other computing devices or networks. As an example, and not by way of limitation, the communication interface 810 may include a network interface controller (NIC) or network adapter for communicating with an Ethernet or other wire-based network or a wireless NIC (WNIC) or wireless adapter for communicating with a wireless network, such as a WI-FI.

Additionally, the communication interface 810 may facilitate communications with various types of wired or wireless networks. The communication interface 810 may also facilitate communications using various communication protocols. The communication infrastructure 812 may also include hardware, software, or both that couples components of the computing device 800 to each other. For example, the communication interface 810 may use one or more networks and/or protocols to enable a plurality of computing devices connected by a particular infrastructure to communicate with each other to perform one or more aspects of the processes described herein. To illustrate, the digital content campaign management process can allow a plurality of devices (e.g., a client device and server devices) to exchange information using various communication networks and protocols for sharing information such as electronic messages, user interaction information, engagement metrics, or campaign management resources.

In the foregoing specification, the present disclosure has been described with reference to specific exemplary embodiments thereof. Various embodiments and aspects of the present disclosure(s) are described with reference to details discussed herein, and the accompanying drawings illustrate the various embodiments. The description above and drawings are illustrative of the disclosure and are not to be construed as limiting the disclosure. Numerous specific details are described to provide a thorough understanding of various embodiments of the present disclosure.

The present disclosure may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the present application is, therefore, indicated by the appended claims rather than by the foregoing description. All changes that come within the meaning and range of equivalency of the claims are to be embraced within their scope.

What is claimed is:

1. A computer-implemented method comprising:
receiving, by one or more servers from a merchant system, a request message comprising a transaction amount and a card identification number associated with a multi-funding source transaction;
determining, by the one or more servers and from an account mapping for the card identification number in an account mapping database, a plurality of proportions corresponding to a plurality of accounts, the plurality of proportions comprising a first proportion corresponding to a first payment account and a second proportion corresponding to a second payment account;
generating, by the one or more servers and based on the transaction amount, a first authorization message comprising an authorization request for the multi-funding source transaction against the first payment account according to the first proportion;
generating, by the one or more servers and based on the transaction amount, a second authorization message comprising an authorization request for the multi-funding source transaction against the second payment account according to the second proportion; and
processing the multi-funding source transaction by sending the first authorization message and the second authorization message to one or more payment networks.

2. The computer-implemented method as recited in claim 1, wherein determining the first proportion corresponding to the first payment account and the second proportion corresponding to the second payment account comprises:
determining that the account mapping for the card identification number links the card identification number to the first payment account and the second payment account; and
determining the first proportion and the second proportion based on the account mapping and the transaction amount.

3. The computer-implemented method as recited in claim 1, wherein determining the first proportion corresponding to the first payment account and the second proportion corresponding to the second payment account comprises determining the first proportion as a first percentage of the transaction amount and the second proportion as a second percentage of the transaction amount.

4. The computer-implemented method as recited in claim 1, wherein determining the first proportion corresponding to the first payment account and the second proportion corresponding to the second payment account comprises:
determining the first proportion as a fixed amount based on the account mapping; and
determining the second proportion based on a difference between the fixed amount and the transaction amount.

5. The computer-implemented method as recited in claim 1, wherein determining the first proportion corresponding to the first payment account and the second proportion corresponding to the second payment account comprises:
determining a plurality of attributes associated with the multi-funding source transaction and the merchant system; and
determining the first proportion and the second proportion based on the plurality of attributes.

6. The computer-implemented method as recited in claim 1, further comprising:
authenticating the first payment account according to first account credentials associated with a first account type;
authenticating the second payment account according to second account credentials associated with a second account type different from the first account type; and
generating the account mapping for the card identification number in response to authenticating the first payment account and authenticating the second payment account.

7. The computer-implemented method as recited in claim 1, further comprising:
generating the first authorization message in response to verifying an account balance associated with the first payment account; and
generating the second authorization message in response to verifying an account balance associated with the second payment account.

8. The computer-implemented method as recited in claim 1, further comprising:
generating the first authorization message comprising a transaction identifier based on the card identification number and the merchant system; and
generating the second authorization message comprising the transaction identifier based on the card identification number and the merchant system.

9. The computer-implemented method as recited in claim 1, further comprising:
generating, in response to processing the multi-funding source transaction, a transaction completion message comprising the transaction amount, a first payment amount corresponding to the first payment account, and a second payment amount corresponding to the second payment account; and
sending the transaction completion message to one or more client devices associated with the card identification number.

10. A system comprising:
at least one processor; and
at least one non-transitory computer readable storage medium comprising instructions that, when executed by the at least one processor, cause the system to:
receive, from a merchant system, a request message comprising a transaction amount and a card identification number associated with a multi-funding source transaction;
determine, from an account mapping for the card identification number in an account mapping database, a plurality of proportions corresponding to a plurality of payment accounts, the plurality of proportions comprising a first proportion corresponding to a first payment account and a second proportion corresponding to a second payment account;
generate, based on the transaction amount, a first authorization message comprising an authorization request for the multi-funding source transaction against the first payment account according to the first proportion;
generate, based on the transaction amount, a second authorization message comprising an authorization request for the multi-funding source transaction against the second payment account according to the second proportion; and
processing the multi-funding source transaction by sending the first authorization message and the second authorization message to one or more payment networks.

11. The system as recited in claim 10, further comprising instructions that, when executed by the at least one processor, cause the system to determine the first proportion corresponding to the first payment account and the second proportion corresponding to the second payment account by:
accessing, from a multi-funding source mapping database, the account mapping based on the card identification number;
determining the first proportion based on the transaction amount and a first percentage corresponding to the first payment account in the account mapping; and
determining the second proportion based on the transaction amount and a second percentage corresponding to the second payment account in the account mapping.

12. The system as recited in claim 10, further comprising instructions that, when executed by the at least one processor, cause the system to determine the first proportion corresponding to the first payment account and the second proportion corresponding to the second payment account by:
determining a plurality of attributes comprising a merchant type, a merchant location, or a transaction time associated with the multi-funding source transaction and the merchant system;
determining a validity of the multi-funding source transaction for the card identification number based on the plurality of attributes; and
determining the first proportion and the second proportion based on the validity of the multi-funding source transaction.

13. The system as recited in claim 10, further comprising instructions that, when executed by the at least one processor, cause the system to:
receive, from an additional merchant system, an additional request message comprising the card identification number associated with a payment transaction;
determine a plurality of attributes associated with the payment transaction and the additional merchant system;
determine, based on the plurality of attributes, that the payment transaction does not qualify as a multi-funding source payment transaction; and
process, via the one or more payment networks, the payment transaction utilizing the first payment account.

14. The system as recited in claim 10, further comprising instructions that, when executed by the at least one processor, cause the system to:
generate the first authorization message according to a first account type associated with the first payment account;
generate the second authorization message according to a second account type associated with the second payment account, the first account type being different from the second account type; and
providing the first authorization message and the second authorization message to the one or more payment networks in parallel.

15. The system as recited in claim 10, further comprising instructions that, when executed by the at least one processor, cause the system to:
authenticate, via the one or more payment networks, the first payment account and the second payment account;
determine one or more account parameters associated with the first payment account or the second payment account; and
link the first payment account and the second payment account to the card identification number within the account mapping according to the one or more account parameters.

16. The system as recited in claim 10, further comprising instructions that, when executed by the at least one processor, cause the system to:
generate the first authorization message comprising a first amount based on the first proportion and a transaction identifier based on the card identification number and the merchant system; and
generate the second authorization message comprising a second amount based on the second proportion and the transaction identifier based on the card identification number and the merchant system.

17. The system as recited in claim 10, further comprising instructions that, when executed by the at least one processor, cause the system to:
update, in response to a request, the account mapping to link a third payment account to the card identification number; and
modify transaction parameters associated with the account mapping based on the first payment account, the second payment account, and the third payment account.

18. A non-transitory computer readable storage medium comprising instructions that, when executed by at least one processor, cause a computing device to:
receive, from a merchant system, a request message comprising a transaction amount and a card identification number associated with a multi-funding source transaction;
determine, from an account mapping for the card identification number in an account mapping database, a plurality of proportions corresponding to a plurality of payment accounts, the plurality of proportions comprising a first proportion corresponding to a first payment account and a second proportion corresponding to a second payment account;
generate, based on the transaction amount, a first authorization message comprising an authorization request for the multi-funding source transaction against the first payment account according to the first proportion;
generate, based on the transaction amount, a second authorization message comprising an authorization request for the multi-funding source transaction against the second payment account according to the second proportion; and
processing the multi-funding source transaction by sending the first authorization message and the second authorization message to one or more payment networks.

19. The non-transitory computer readable storage medium as recited in claim 18, further comprising instructions that, when executed by the at least one processor, cause the computing device to determine the first proportion corresponding to the first payment account and the second proportion corresponding to the second payment account by:
determining the first proportion based on the transaction amount and a first percentage corresponding to the first payment account in the account mapping; and
determining the second proportion based on the transaction amount and a second percentage corresponding to the second payment account in the account mapping.

20. The non-transitory computer readable storage medium as recited in claim 18, further comprising instructions that, when executed by the at least one processor, cause the computing device to:
determine a plurality of attributes associated with the multi-funding source transaction; and
validate the multi-funding source transaction for the card identification number based on the plurality of attributes.
